(19) United States
(12) Patent Application Publication
(10) Pub. No.: US 2026/0141792 A1
(43) Pub. Date: May 21, 2026

(54) Sheet Dispenser Arrangement

(71) Applicant: Diebold Nixdorf, Incorporated, North Canton, OH (US)

(72) Inventors: Michael J. Harty, Canton, OH (US); William Beskitt, Canton, OH (US)

(21) Appl. No.: 19/118,395

(22) PCT Filed: Oct. 6, 2023
(86) PCT No.: PCT/US2023/034668

§ 371 Date: Apr. 4, 2025

Related U.S. Application Data
(60) Provisional application No. 63/414,249, filed on Oct. 7, 2022.

(51) Int. Cl. G07F 19/00; G07D 11/14

(52) U.S. Cl. CPC G07F 19/203; G07D 11/14; G07D 2211/00

(57) ABSTRACT

A sheet dispenser arrangement for an automated transaction machine (ATM) can include a shuttle frame guide, a shuttle frame, and a shuttle assembly. The shuttle frame guide can be configured to be positioned in the ATM. The shuttle frame can be telescopically engaged with the shuttle frame guide. The shuttle frame can be moveable between first and second end limits of travel. The shuttle frame can be moveable relative to the shuttle frame guide between a retracted position and an extended position. The shuttle assembly can be telescopically engaged with the shuttle frame. The shuttle assembly can be moveable between first and second end limits of travel. The shuttle assembly can be moveable relative to the shuttle frame between a retracted position and an extended position.

### CROSS-REFERENCE TO RELATED APPLICATION

The application claims the priority benefit of Application Ser. No. 63/414,249 for a SHEET DISPENSER ARRANGEMENT, filed on Oct. 7, 2022, in the United States, which is hereby incorporated by reference in its entirety.

### BACKGROUND

### 1. Field

The present disclosure relates to a sheet dispenser arrangement, such as utilized in automated transaction machines which dispense sheets in the form of sheets of currency.

### 2. Description of Related Prior Art

U.S. Pat. No. 5,234,209 discloses a dispensing unit for paper currency. The dispensing unit for paper currency includes a box-shaped currency container with a circuit that stores an identification code and with a frame-like receptacle module into which the currency container can be inserted, and a contact arrangement of the currency container can be connected by a mating contact arrangement mounted on the receptacle module to a polling and control circuit that controls the opening or locking of the currency container. In order to permit polling of the circuit in the currency container during the insertion movement, the mating contact arrangement is adjustable in the direction of insertion of the currency container. An adjustable locking element which is mounted on receptacle module or on the currency container and can be controlled by the control system, engages a catch element on the other part such that in the engaged position of the locking element and the catch element, the currency container is some distance away from a draw-off and single feed mechanism of the receptacle module such that opening of its closure is possible.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

This section provides a simplified summary in order to provide a basic understanding of some aspects described herein. This summary is not an extensive overview and is not intended to identify “key” or “critical” elements of the present disclosure or to delineate the scope of the various aspects described herein. The purpose of this portion of the document is to present some concepts in a simplified form as a prelude to the more detailed description that is presented later.

A sheet dispenser arrangement for an automated transaction machine (ATM) can include a shuttle frame guide, a shuttle frame, and a shuttle assembly. The shuttle frame guide can be configured to be positioned in the ATM. The shuttle frame can be telescopically engaged with the shuttle frame guide. The shuttle frame can be moveable between first and second end limits of travel. The shuttle frame can be moveable relative to the shuttle frame guide between a retracted position and an extended position. The shuttle assembly can be telescopically engaged with the shuttle frame. The shuttle assembly can be moveable between first and second end limits of travel. The shuttle assembly can be moveable relative to the shuttle frame between a retracted position and an extended position.

According to other features, the sheet dispenser arrangement of claim 1 can also include a transmission assembly having at least one motor with an output shaft. The transmission assembly can be configured to convert rotation of the output shaft of the motor into rectilinear motion of both of the shuttle frame as well as the shuttle assembly. The transmission assembly can be further defined as positioned on a single side of at least one of the shuttle frame and the shuttle assembly. The transmission assembly can be further defined as positioned on a single side of both of the shuttle frame as well as the shuttle assembly. The at least one motor can be further defined as a single motor.

In other features, the transmission assembly can include at least one first belt engaged with the output shaft whereby the at least one first belt is driven in motion by rotation of the output shaft. The transmission assembly can also include a first pulley mounted on the shuttle frame for rotation relative to the shuttle frame, wherein the at least one first belt extends around the first pulley whereby motion of the at least one first belt causes rotation of the first pulley. The transmission assembly can also include a gear having a first set of gear teeth and mounted on the shuttle frame for rotation relative to the shuttle frame. The first pulley can have a second set of gear teeth. The first pulley and the gear can be meshed together for concurrent rotation.

According to additional features, the transmission assembly can also include a second pulley mounted on the shuttle frame for rotation relative to the shuttle frame and spaced from the first pulley. The second pulley can have a third set of gear teeth. The gear and the second pulley can be meshed together for concurrent rotation. The transmission assembly can also include at least one second belt engaged with the second pulley whereby the at least one second belt can be driven in motion by rotation of the second pulley.

According to other features, the shuttle assembly can include at least one tab, wherein the at least one tab can be fixed to the at least one second belt. The shuttle frame can include at least one slot. The at least one tab can be received in the at least one slot and can be movable between opposite ends of the at least one slot. The transmission assembly can also include a third pulley mounted on the shuttle frame for rotation relative to the shuttle frame. The third pulley can be spaced from the first pulley and spaced from the second pulley. The at least one first belt can extend around the third pulley.

In other features, the transmission assembly can be further defined as configured to move the shuttle assembly to the extended position of the shuttle assembly while the shuttle frame is stationary. The transmission assembly can be further defined as configured to move the shuttle frame to the extended position of the shuttle frame only after the shuttle assembly is moved to the extended position of the shuttle assembly.

According to additional features, the sheet dispenser arrangement can also include a controller configured to control operation of the at least one motor. The sheet dispenser arrangement can also include at least one sensor configured to sense a position of at least one of the shuttle assembly and the shuttle frame. The at least one sensor can also be configured to transmit a signal to the controller corresponding to the position of at least one of the shuttle assembly and the shuttle frame. The controller can also be configured to control operation of the at least one motor in response to the signal.

According to other features, The sheet dispenser arrangement can also include a locking assembly. The locking assembly can be in a locked configuration when the shuttle assembly is in the extended position of the shuttle assembly. The locking assembly can be in an unlocked configuration when the shuttle assembly is spaced from the extended position of the shuttle assembly. The locking assembly can include a gear train, at least one first belt, and at least one second belt. The gear train can include at least a first gear mounted on the shuttle frame. The at least one first belt can be engaged with the first gear that can be mounted on the shuttle frame. The at least one second belt can be engaged with at least a second gear of the gear train. The second gear can be mounted on the shuttle frame.

In other features, the sheet dispenser arrangement can also include a motor, a first pulley, a first belt, a second pulley, a third pulley, a second belt, and a tab. The motor can be fixed relative to the shuttle frame guide and can have an output shaft. The first pulley can be mounted on the output shaft. The first belt can extend around the first pulley and thereby driven in motion by rotation of the output shaft by the motor. The second pulley can be fixed relative to the shuttle frame. The first belt can extend around the second pulley and the second pulley can thereby be driven in rotation by rotation of the output shaft. The third pulley can be fixed relative to the shuttle frame and can be spaced from the second pulley. The second belt can extend around the third pulley and can thereby be driven in motion by rotation of the third pulley. The tab can be mounted on the second belt and can thereby move with the second belt when the second belt moves.

According to additional features, the shuttle assembly can include at least one tab. The shuttle frame can include at least one slot. The at least one tab can be received in the at least one slot. The shuttle frame can guide movement of the shuttle assembly relative to the shuttle frame through cooperative interaction between the at least one tab and the at least one slot.

### BRIEF DESCRIPTION OF THE DRAWINGS

The detailed description set forth below references the following drawings:

FIG. 1 is a first perspective view of a sheet dispenser arrangement according to an exemplary embodiment of the present disclosure in a first operating environment;

FIG. 2 is a second perspective view of the exemplary sheet dispenser arrangement in the first operating environment;

FIG. 3 is a cross-sectional view taken at section lines 3-3 in FIGS. 1 and 2, wherein the exemplary sheet dispenser arrangement is in the first operating environment, and further shows a shuttle assembly and a shuttle frame of the exemplary sheet dispenser arrangement both in respective retracted positions;

FIG. 4 is a cross-sectional view in the same sectional plane as shown in FIG. 3, but is taken of the exemplary sheet dispenser arrangement in a second operating environment;

FIG. 5 is a cross-sectional view in the same sectional plane as shown in FIG. 3, but is taken of the exemplary sheet dispenser arrangement in a third operating environment;

FIG. 6 is a first perspective view of the sheet dispenser arrangement in the third operating environment;

FIG. 7 is a second perspective view of the sheet dispenser arrangement in the third operating environment;

FIG. 8 is a cross-sectional view in the same sectional plane as shown in FIG. 6, wherein the exemplary sheet dispenser arrangement is in the third operating environment, and further shows the shuttle assembly and the shuttle frame both in respective extended positions;

FIG. 9 is a cross-sectional view in the same sectional plane as shown in FIG. 3, wherein the exemplary sheet dispenser arrangement is in the first operating environment, and further shows the shuttle assembly in the extended position and the shuttle frame in the retracted position;

FIG. 10 is a perspective view of a transmission assembly of the exemplary sheet dispenser arrangement;

FIG. 11 is a magnified portion of FIG. 3; and

FIGS. 12A, 12B, and 12C are sequential images of extension of the shuttle assembly and the shuttle frame.

### DETAILED DESCRIPTION

The present disclosure, as demonstrated by the exemplary embodiment described below, provides a sheet dispenser arrangement that can accommodate a plurality of different operating environments. An exemplary sheet dispenser arrangement according to the present disclosure is referenced at 10 in the Figures. By way of example and not limitation, an embodiment of the exemplary sheet dispenser arrangement 10 can utilized within an automated transaction machine (ATM). The exemplary sheet dispenser arrangement 10 includes a plurality of cassettes 12, 112, 212 that are configured to hold and receive sheets of currency. The exemplary sheet dispenser arrangement 10 also includes a frame 14 that is configured to hold the cassettes 12, 112, 212 and maintain the cassettes 12, 112, 212 in a predetermined position and location. It is noted that in one or more embodiments of the present disclosure, the cassettes 12, 112, 212 and the frame 14 can be contained within a safe (not shown in the Figures).

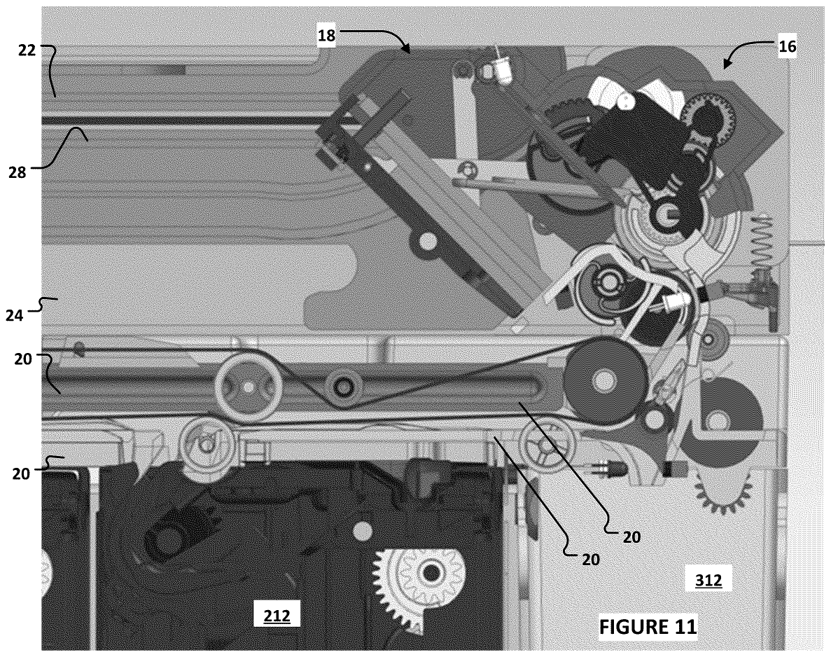

The exemplary sheet dispenser arrangement 10 also includes a loading assembly 16, a exemplary shuttle assembly 18, and a transport assembly 20. Generally, the exemplary transport assembly 20 is configured to transport sheets of currency between the cassettes 12, 112, 212 and the loading assembly 16. The exemplary transport assembly 20 can transport sheets of currency from one or more of the cassettes 12, 112, 212 to the loading assembly 16 and can transport sheets of currency from the loading assembly 16 to a retract compartment referenced at 312 in FIG. 11. The exemplary transport assembly 20 can include gears, shafts, belts, rollers, plates, vane wheels, motors, and/or other structures that are commonly included in assemblies that move currency. The exemplary loading assembly 16 is configured to transfer sheets of currency from the exemplary transport assembly 20 to the exemplary shuttle assembly 18 and from the exemplary shuttle assembly 18 to the exemplary transport assembly 20. The exemplary loading assembly 16 can thus also include gears, shafts, belts, rollers, plates, vane wheels, motors, and/or other structures that are commonly included in assemblies that move currency.

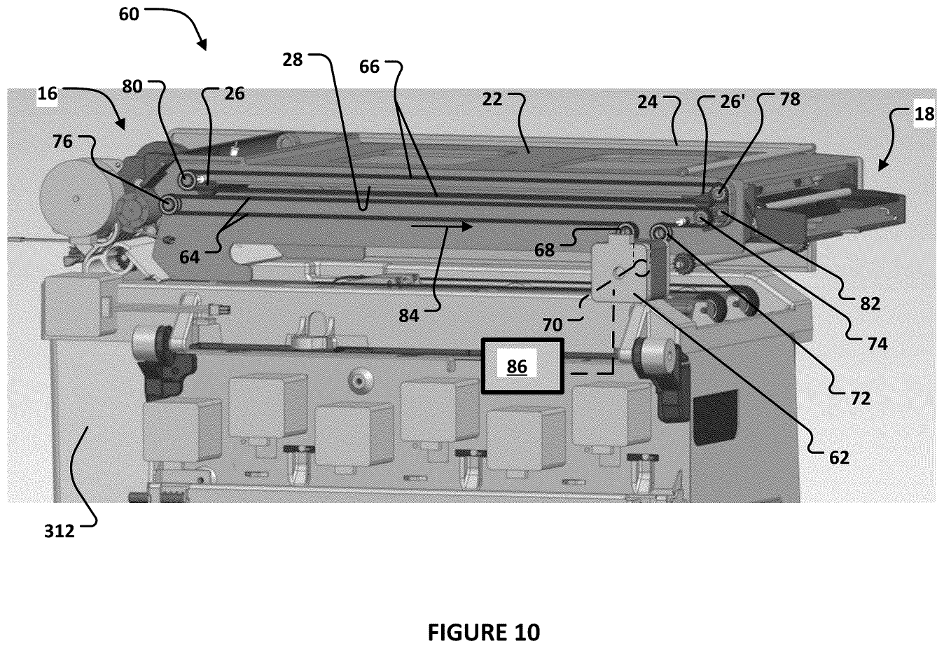

The exemplary sheet dispenser arrangement 10 also includes a exemplary shuttle frame 22 and a exemplary shuttle frame guide 24. The exemplary shuttle frame 22 supports the exemplary shuttle assembly 18 and guides movement of the exemplary shuttle assembly 18. In the exemplary embodiment, the exemplary shuttle assembly 18 includes a key or tab 26 and the exemplary shuttle frame 22 includes a slot 28 in which the tab 26 slides. As best shown in FIG. 10, the tab 26 (and thus the exemplary shuttle assembly 18) is moveable relative to the exemplary shuttle frame 22 within the slot 28 between a first end limit of travel referenced by 26 in FIG. 10 and a second end limit of travel referenced by 26′ in FIG. 10. In FIG. 10, the tab referenced at 26′ is shown for reference (to explain the second end limit of travel) and the tab referenced at 26 is the actual location of the tab based on how the other components in the Figure are shown. The exemplary shuttle assembly 18 is thus telescopically engaged with the exemplary shuttle frame 22. The exemplary shuttle assembly 18 is in its retracted position in FIG. 10, when the tab 26 is at its first end limit of travel. The exemplary shuttle assembly 18 is in its extended position when the tab 26 is at its second end limit of travel (reference tab 26′). It is noted that the second end limit of travel of the exemplary shuttle assembly 18 can be varied among different embodiments of the present disclosure by modifying the length of the slot 28.

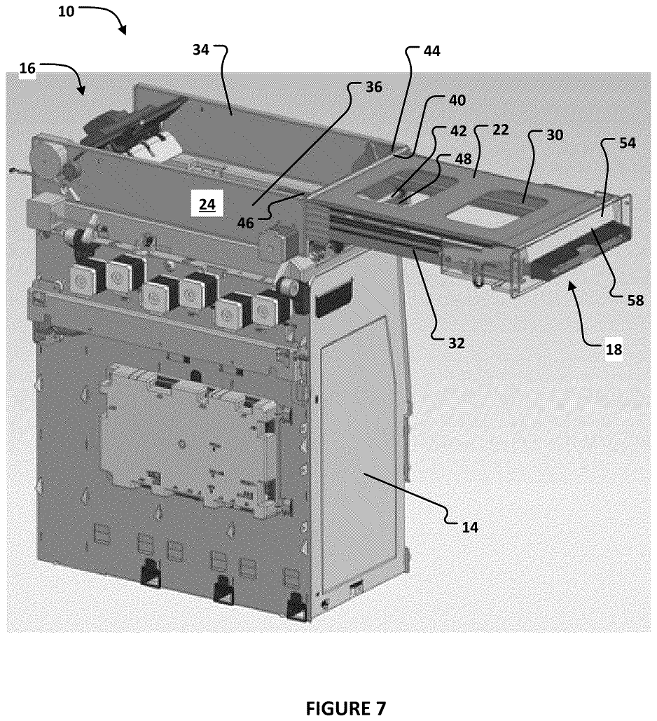

The exemplary shuttle frame guide 24 is fixed relative to the exemplary transport assembly 20 and to the exemplary cassettes 12, 112, 212. The exemplary shuttle frame guide 24 supports the exemplary shuttle frame 22 and guides movement of the exemplary shuttle frame 22 relative to the exemplary shuttle frame guide 24. In the exemplary embodiment, as best shown in FIG. 7, lateral walls 30, 32 of the exemplary shuttle frame 22 are slidably contained within lateral walls 34, 36 of the exemplary shuttle frame guide 24. The exemplary shuttle frame 22 can be supported by the lateral walls 34, 36 and prevented from shifting in lateral, side to side movement. Outer side surfaces of the lateral walls 30, 32 can slide across inner side surfaces of the lateral walls 34 and 36 of the exemplary transport assembly 20. Further, the lateral walls 34, 36 can include structural features, such as tracks or slots, that prevent the lateral walls 30, 32 from shifting in vertical, up and down movement or rocking movement. The exemplary shuttle frame 22 is thus telescopically engaged with the exemplary shuttle frame guide 24.

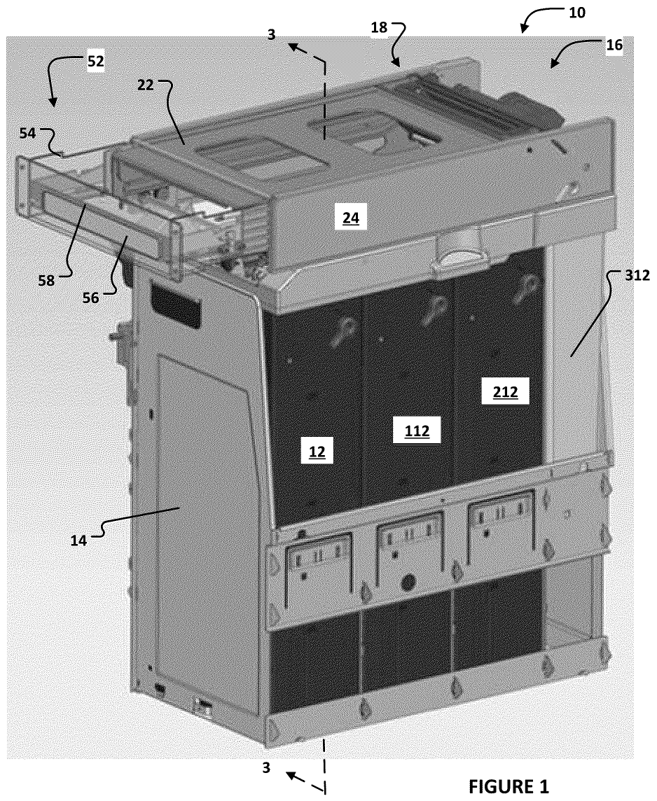

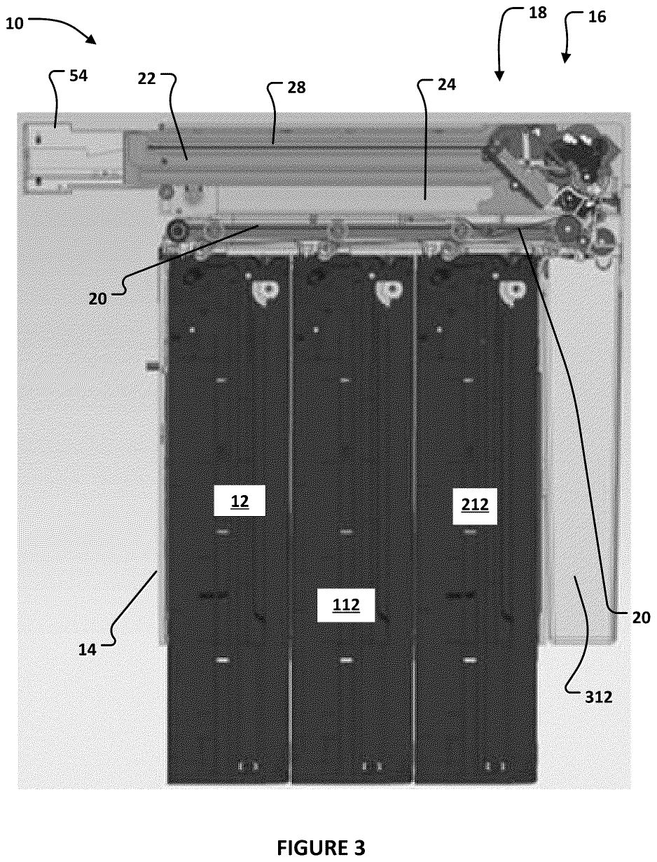

The exemplary shuttle frame 22 is moveable relative to the exemplary shuttle frame guide 24 within the lateral walls 34, 36 between a first end limit of travel and a second end limit of travel. The exemplary shuttle frame 22 is shown at its first end limit of travel in FIGS. 1, 3-5 , and 9-11. The exemplary shuttle frame 22 is in a retracted position, relative to the exemplary shuttle frame guide 24, when at its first end limit of travel. When the exemplary shuttle assembly 18 and the exemplary shuttle frame 22 are both at their respective first end limits of travel for a particular operating environment, also herein designated as their respective retracted positions, sheets of currency can be loaded onto or removed from the exemplary shuttle assembly 18 by the exemplary loading assembly 16.

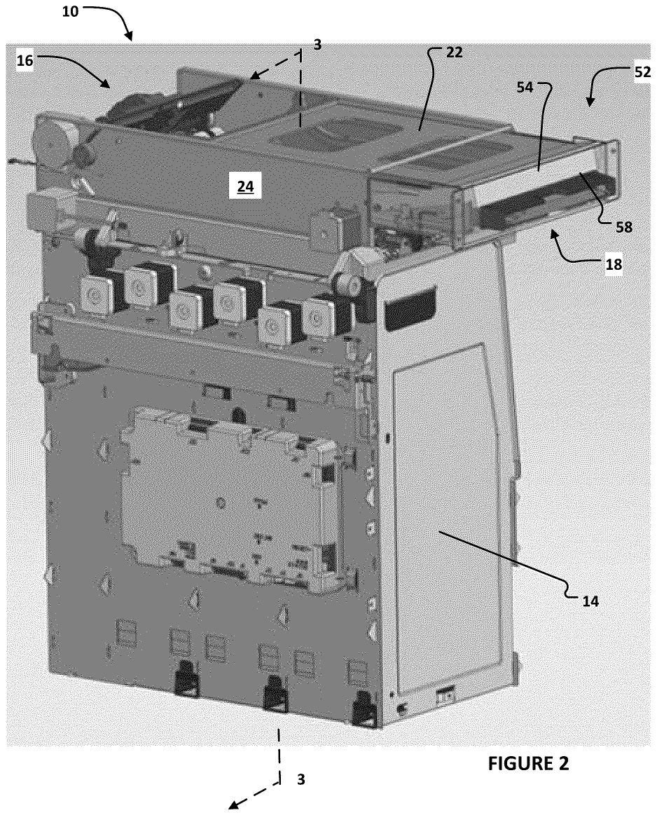

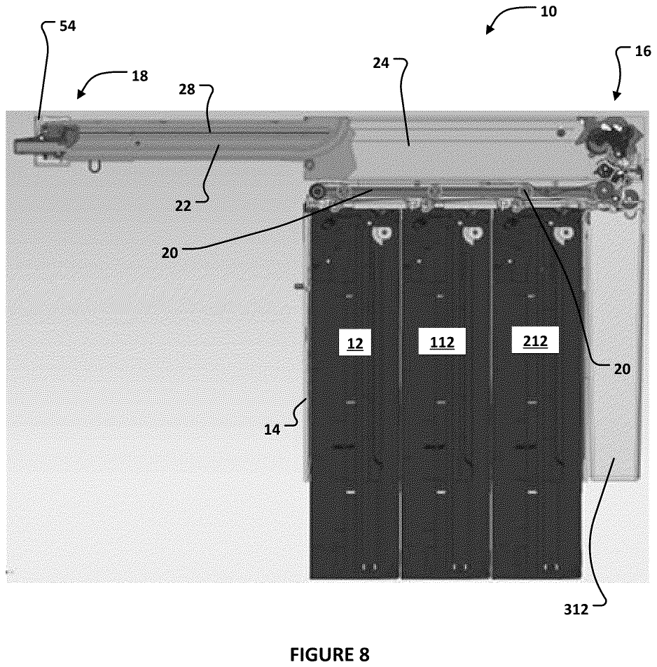

The exemplary shuttle frame 22 is shown at its second end limit of travel in FIGS. 2 and 6-8. The exemplary shuttle frame 22 is in its extended position when at its second end limit of travel. When the exemplary shuttle assembly 18 and the exemplary shuttle frame 22 are both at their respective second end limits of travel, also herein designated as their respective extended positions, sheets of currency can be loaded onto or removed from the exemplary shuttle assembly 18 by a human user through a bezel 54, for example. The bezel 54 can, for example, be mounted in a fascia of an ATM.

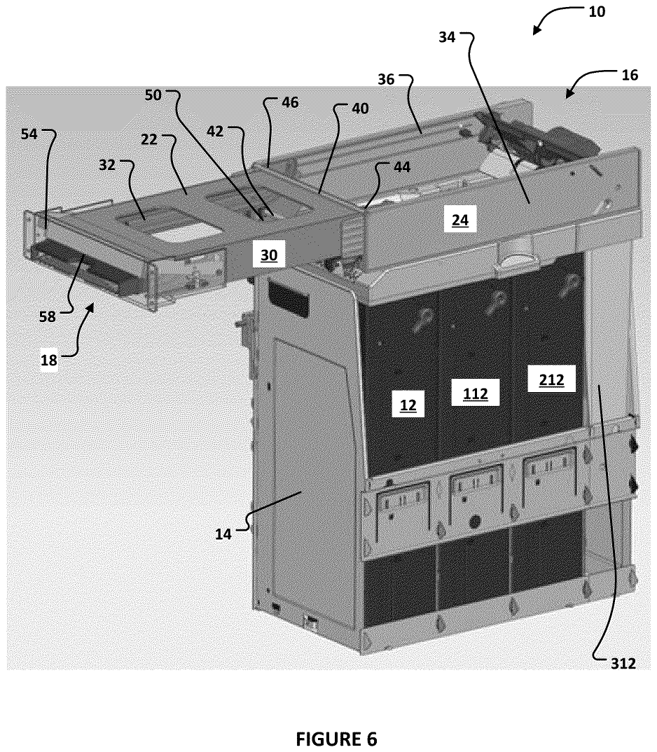

The second end limit of travel of the exemplary shuttle frame 22 can be defined or selected by the positioning of other structures which would limit the movement of the exemplary shuttle frame 22. In one example, with reference to FIGS. 6 and 7, the exemplary shuttle frame guide 24 includes rods 40, 42 and the exemplary shuttle frame 22 includes hooks or catches 44, 46, 48, 50. The exemplary rods 40, 42 are fixed to the exemplary lateral walls 34, 36. The exemplary catches 44, 46, 48, 50 are defined by the exemplary lateral walls 34, 36. The exemplary shuttle frame 22 reaches its second end limit of travel and its extended position when the rod 40 is received in the catches 44 and 46 and when the rod 42 is received in the catches 48 and 50. In another example, the second end limit of travel of the exemplary shuttle frame 22 can be defined by the position of the bezel 54. The exemplary shuttle frame 22 can be moved until it contacts the bezel 54, which thus defines its extended position.

An input/output assembly is referenced at 52. The exemplary input/output assembly 52 includes the bezel 54 and a shutter or door 56. The exemplary bezel 54 defines a slot 58. The door 56 can by moved by exemplary shuttle frame 22 to move the door 56 to open and close the slot 58. The exemplary shuttle assembly 18 can transport sheets of currency received from the loading assembly 16 to the input/output assembly 52 (to be provided to the user) and can transport sheets of currency retracted from the input/output assembly 52 (not taken by the user) to the loading assembly 16.

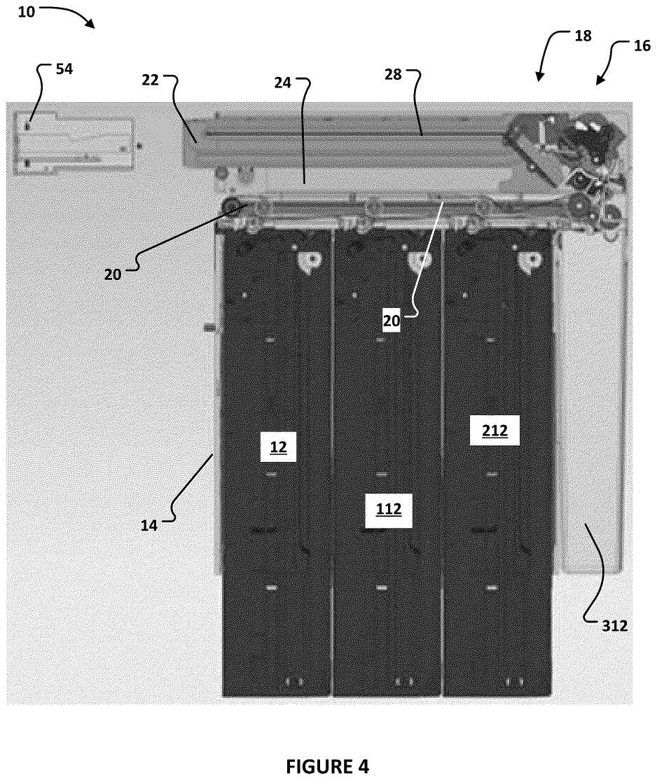

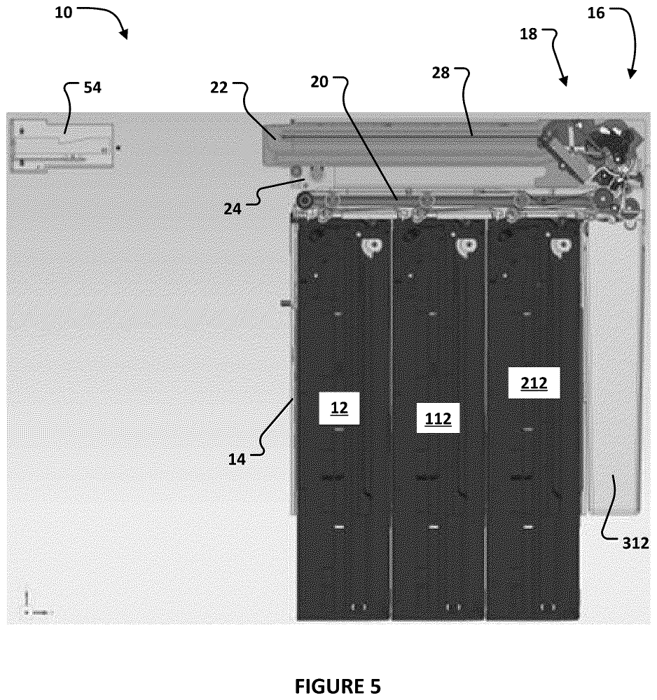

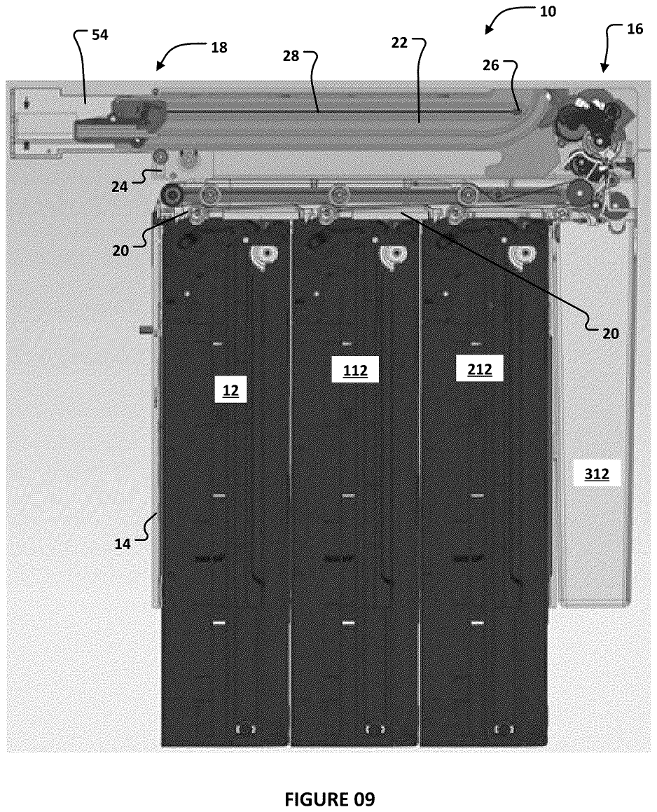

The different positions of the input/output assembly 52 relative to the exemplary sheet dispenser arrangement 10 correspond to different operating environments. As set forth above, the exemplary sheet dispenser arrangement 10 can accommodate a plurality of different operating environments. For example, FIGS. 1-3 and 9 correspond to a first operating environment in which the input/output assembly 52 is relatively close to the exemplary sheet dispenser arrangement 10 in operation. In the first operating environment, no or a relatively small length of extension of the exemplary shuttle frame 22 from the exemplary shuttle frame guide 24 occurs when currency is moved to the bezel 54 for disbursement. FIGS. 5-8 correspond to a third operating environment in which the input/output assembly 52 is relatively far from the exemplary sheet dispenser arrangement 10 in operation. In the third operating environment, a relatively large length of extension of the exemplary shuttle frame 22 from the exemplary shuttle frame guide 24 occurs when currency is moved to the bezel 54 for disbursement. FIG. 4 corresponds to a second operating environment in which the input/output assembly 52 is in between the positions shown in the first and third operating environments. In the second operating environment, a relatively medium length of extension of the exemplary shuttle frame 22 from the exemplary shuttle frame guide 24 occurs when currency is moved to the bezel 54 for disbursement.

Referring now to FIG. 10, the exemplary sheet dispenser arrangement 10 also includes a transmission assembly 60. As shown in FIG. 10, the exemplary transmission assembly 60 is positioned on a single side of both of the of the exemplary shuttle frame 22 as well as the exemplary shuttle assembly 18. The exemplary transmission assembly 60 includes a motor 62. The exemplary transmission assembly 60 also includes a first belt 64 and a second belt 66. The exemplary transmission assembly 60 also includes pulleys 68, 70, 72, 74, 76. The exemplary first belt 64 extends around the pulleys 68, 70, 72, 74, 76. The exemplary pulleys 68 and 72 are mounted for rotation to the exemplary shuttle frame guide 24. It is noted that the lateral wall 36 has been omitted from FIG. 10 to allow other structures to be visible. The pulleys 74 and 76 are mounted for rotation to the exemplary shuttle frame 22. The pulley 70 is mounted on the output shaft of the motor 62.

The exemplary transmission assembly 60 also includes pulleys 78, 80. The exemplary second belt 66 extends around the pulleys 78, 80. The exemplary pulleys 78 and 80 are mounted for rotation to the exemplary shuttle frame 22. The exemplary tab 26 is fixed to the exemplary second belt 66. The exemplary pulleys 74 and 78 include gear teeth. The exemplary transmission assembly 60 also includes a gear 82 that can mesh with both of the pulleys 74 and 78 when moved into engagement with one another. The exemplary gear 82 is mounted for rotation on the exemplary shuttle frame 22. Rotation of the pulley 74 is transmitted to rotate the pulley 78 through the respective meshed teeth among the pulleys 74 and 78 and the gear 82.

In a method of moving the components of the exemplary sheet dispenser arrangement 10, to extend the exemplary shuttle assembly 18 relative to the exemplary shuttle frame 22 and to extend the exemplary shuttle frame 22 relative to the exemplary shuttle frame guide 24, the motor 62 can rotate its output shaft/pulley 70 in a counter-clockwise (CCW) direction (based on the perspective shown in FIG. 10). This results in the movement of the portion of the belt 64 that extends between the pulleys 76 and 68 in a direction referenced at 84. Further, CCW rotation of the output shaft/pulley 70 results in CCW rotation of the pulley 74, which results in clockwise (CW) rotation of the gear 82 because of the meshed teeth between the output shaft/pulley 70 and the gear 82, which results in CCW rotation of the pulley 78 because of the meshed teeth between the gear 82 and the pulley 78. Further, CCW rotation of the output shaft/pulley 70 results in the bottom side of the second belt 66 (based on the perspective of FIG. 10) moving in the direction 84. A top side of the second belt 66 thus moves in a direction opposite to the direction 84.

The exemplary tab 26 is fixed to the bottom half of the second belt 66. When the exemplary shuttle assembly 18 and the exemplary shuttle frame 22 are in their respective first end limits of travel at the start of movement, the tab 26 is at the position shown in FIG. 10. CCW rotation of the output shaft/pulley 70 results in movement of the tab 26 by the second belt 66, within the slot 28. The tab 26 moves to the right based on the perspective shown in FIG. 10. As the tab 26 moves to the position referenced at 26′, the exemplary shuttle assembly 18 moves, relative to the exemplary shuttle frame 22, from its retracted position to its extended position. This movement is telescopic extension of the exemplary shuttle assembly 18 relative to the exemplary shuttle frame 22. During the movement of the exemplary shuttle assembly 18 thus far described, the exemplary shuttle frame 22 does not move relative to the exemplary shuttle frame guide 24.

When the tab 26 reaches the position referenced by 26′, the exemplary shuttle assembly 18 has reached the extended position. At this time, the exemplary tab 26 has reached an end of the exemplary slot 28 and cannot move further to the right relative to the exemplary shuttle frame 22. Further, the interconnection between the tab 26 and the belt 66 and also the engagement between the tab 26 and the end of the slot 28 prevents further movement of the belt 66 and, as a result, further rotation of the pulleys 78 and 80 despite further rotation of the output shaft/pulley 70 of the motor 62 in the CCW direction. For example, the pulley 78 and its gear teeth are “locked.” Further still, the meshed relationships among the gear 82 and the pulleys 74, 78 results in the gear 82 and the pulley 74 being locked.

Rotation of the output shaft/pulley 70 of the motor 62 in the CCW direction after the tab 26 has reached the position referenced at 26′ will result in movement of the exemplary shuttle frame 22 from its retracted position to the extended position. Further CCW rotation of the output shaft/pulley 70 of the motor 62 will draw the pulley 76 to the right based on the perspective shown in FIG. 10. Because the exemplary pulley 76 is rectilinearly fixed to the exemplary shuttle frame 22, the exemplary shuttle frame 22 will also be drawn to the right. This movement is telescopic extension of the exemplary shuttle frame 22 relative to the exemplary shuttle frame guide 24. This movement can continue until the rods 40, 42 are received in the catches 44, 46, 48, 50, or the exemplary shuttle assembly 18 contacts the bezel 54.

When the exemplary shuttle assembly 18 and the exemplary shuttle frame 22 have been moved to their respective extended positions, at least part of the exemplary shuttle assembly 18 can at least partially extend through the slot 58 to dispense sheets of currency carried by the exemplary shuttle assembly 18 or to retract sheets of currency not taken by a user. After the exchange of sheets of currency, the exemplary shuttle assembly 18 and the exemplary shuttle frame 22 can be returned to their respective retracted positions. The motor 62 can rotate its output shaft/pulley 70 in the CW direction. Initially, the CW rotation of the output shaft/pulley 70 will result in movement of the exemplary pulley 74 to the left. Because the exemplary pulley 74 is rectilinearly fixed to the exemplary shuttle frame 22, the exemplary shuttle frame 22 will also move to the left. The exemplary shuttle frame 22 will move back to its first end limit of travel, which is its retracted position. After the exemplary shuttle frame 22 is back at its retracted position, the tab 26 will move away from the position referenced at 26′. This will permit rotation of the meshed gear 82 and pulleys 74, 78 to resume. Further rotation of the shaft/pulley 70 in the CW direction will result in the exemplary shuttle assembly 18 will move back to its first end limit of travel, which is its retracted position. The exemplary transmission assembly 60 thus converts rotation of the output shaft of the exemplary motor 62 into rectilinear motion of both of the exemplary shuttle frame 22 as well as the exemplary shuttle assembly 18.

The exemplary sheet dispenser arrangement 10 thus includes a locking assembly. The exemplary locking assembly is embodied in part by the gear train that is made up of the pulley 74, the pulley 78, and the gear 82. The exemplary locking assembly is also embodied in part by the belts 64 and 66. The exemplary locking assembly operates such that it is in a locked configuration when the exemplary shuttle assembly 18 is in its extended position. The exemplary locking assembly also operates such that it is in an unlocked configuration when the exemplary shuttle assembly 18 is spaced from its extended position.

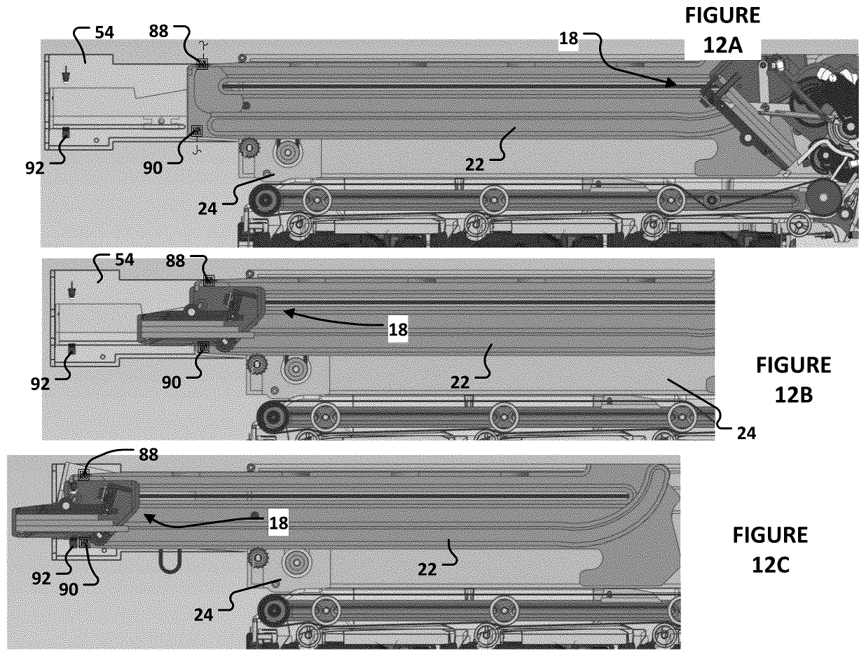

In one or more embodiments of the present disclosure, the sheet dispenser arrangement 10 can be configured to adjust automatically to different extension lengths associated with the various operating environments discussed herein or any other operating environment having an extension length between the extension lengths of the first and third operating environments discussed herein. FIGS. 12A, 12B, and 12C are sequential images of extension of the exemplary shuttle assembly 18 and the exemplary shuttle frame 22. In FIG. 12A, the exemplary shuttle assembly 18 and the exemplary shuttle frame 22 are both in their respective retracted positions. In FIG. 12B, the exemplary shuttle assembly 18 is in its extended position and the exemplary shuttle frame 22 is in its retracted position. In FIG. 12C, the exemplary shuttle assembly 18 and the exemplary shuttle frame 22 are both in their respective extended positions.

Referring now to FIGS. 10 and 12A-12B , the exemplary sheet dispenser arrangement 10 includes a controller 86. The exemplary controller 86 is configured to control the motor 62. The exemplary sheet dispenser arrangement 10 also includes a first sensor 88 and a second sensor 90. The exemplary first sensor 88 and the exemplary second sensor 90 are proximity sensors.

The exemplary first sensor 88 and the exemplary second sensor 90 communicate, to the controller 86, signals corresponding to sensed conditions. The exemplary first sensor 88 and the exemplary second sensor 90 communicate wirelessly with the controller 86, but could communicate with the controller 86 over wire in other embodiments of the present disclosure. The exemplary first sensor 88 and the exemplary second sensor 90 are positioned at a distal end of the exemplary shuttle frame 22. The exemplary first sensor 88 is configured to detect proximity of the exemplary shuttle assembly 18. The exemplary first sensor 88 detects the exemplary shuttle assembly 18 when the exemplary shuttle assembly 18 is in its extended position. The exemplary second sensor 90 is configured to detect proximity of a stop 92 defined by or mounted on the bezel 54. In other embodiments of the present disclosure, the sensors 88, 90 could be configured to detect a condition other than physical proximity in order to detect the positions of the exemplary shuttle assembly 18 and the exemplary shuttle frame 22 and then provide that information to the controller 86. For example, one or both of the sensors 88, 90 could apply vision/laser technology.

In operation, when the exemplary shuttle assembly 18 is to deliver currency to the slot 58 of the bezel 54, the controller 86 can control the motor 62 rotate its output shaft/pulley 70 CCW to thus begin movement of the exemplary shuttle assembly 18, relative to the exemplary shuttle frame 22, from its retracted position toward its extended position. When the exemplary shuttle assembly 18 reaches its extended position, the first sensor 88 can communicate a signal to the controller 86 confirming proximity of the shuttle assembly 88. The controller 86 can continue to control the motor 62 to operate and thus begin movement of the exemplary shuttle frame 22 from its retracted position toward its extended position.

The controller 86 can continue to control the motor 62 to operate until receiving a signal from the second sensor 90. This signal will indicate proximity of the exemplary shuttle frame 22 to the stop 92. Upon receiving the signal from the second sensor 90, the controller 86 can control the motor 62 to cease operating. The transaction with the user can then proceed. The use of the first sensor 88 is thus not strictly necessary to determine when the movement of the exemplary shuttle frame 22 should cease, but can provide a confirmation of desired movement.

In an embodiment of the present disclosure not including the second sensor 90, the motor 62 can be controlled to operate for predetermined period of time or for a predetermined number of revolutions of the output shaft to move the exemplary shuttle assembly 18 and the exemplary shuttle frame 22 to their respective extended positions. Through the use of the second sensor 90, the operation of the motor 62 and the extent of movement of the exemplary shuttle frame 22 can be automated. For example, the exemplary sheet dispenser arrangement 10 can be placed in any operating environment without requiring programming of the controller 86 or motor 62 regarding the extent of operation required to effectuate the desired/necessary extension of the exemplary shuttle assembly 18 and the exemplary shuttle frame 22.

In one or more embodiments of the present disclosure, a sheet dispenser arrangement can include a sensor configured and operable to detect when the shuttle frame is retracted and/or another sensor configured to detect when the shuttle assembly is just behind the shutter/door 56 on the bezel 54. Both of these sensors could be an optical emitter and detector pair. A sensor at the bezel 54 could also detect when sheets of currency are removed from the shuttle assembly 18.

What has been described above includes examples of the subject innovation. It is, of course, not possible to describe every conceivable combination of components or methodologies for purposes of describing the disclosed subject matter, but many further combinations and permutations of the subject innovation are possible. The use of any and all examples, or exemplary language (e.g., “such as”) provided herein is intended merely to be illustrative and does not pose a limitation on the scope of any innovation disclosed herein unless otherwise claimed. The word “exemplary” is used to mean serving as an example, instance, or illustration. Any aspect or design described herein as “exemplary” is not necessarily to be construed as preferred or advantageous over other aspects or designs. Rather, use of the word “exemplary” is intended to present concepts in a concrete fashion. Further, any statements set forth within the Detailed Description of this document and addressing a prior art device(s) are the observations of the inventors and such statements themselves are not prior art or admissions as to what is prior art.

As used herein, the singular forms “a,” “an,” and “the” include plural referents unless the context clearly dictates otherwise. Unless indicated otherwise by context, the term “or” is to be understood as an inclusive “or.” Terms such as “first”, “second”, “third”, etc. when used to describe multiple devices or elements, are so used only to convey the relative actions, positioning and/or functions of the separate devices, and do not necessitate either a specific order for such devices or elements, or any specific quantity or ranking of such devices or elements. Use of the terms “about” or “approximately” are intended to cover values that are above and/or below a stated value or range, or within manufacturing tolerances, as would be understood by one having ordinary skill in the art in the respective context. In some instances, this may encompass values in a range of approx. +/−10%; in other instances there may be encompassed values in a range of approx. +/−5%; in yet other instances values in a range of approx. +/−2% may be encompassed; and in yet further instances, this may encompass values in a range of approx. +/−1%.

It will be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof, unless indicated herein or otherwise clearly contradicted by context. Recitations of a value range herein, unless indicated otherwise, serves as a shorthand for referring individually to each separate value falling within the stated range, including the endpoints of the range, each separate value within the range, and all intermediate ranges subsumed by the overall range, with each incorporated into the specification as if individually recited herein. Unless indicated otherwise, or clearly contradicted by context, methods described herein can be performed with the individual steps executed in any suitable order, including: the precise order disclosed, without any intermediate steps or with one or more further steps interposed between the disclosed steps; with the disclosed steps performed in an order other than the exact order disclosed; with one or more steps performed simultaneously; and with one or more disclosed steps omitted, unless expressly contradicted by the text herein or context.

While the present disclosure has been described with reference to one or more exemplary embodiments, it is to be understood that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to a particular embodiment disclosed herein as the best mode contemplated for carrying out this present disclosure, but that the present disclosure will be viewed as covering any embodiment falling within the scope of the appended claims. Various aspects or features described herein may be implemented as a method, apparatus, or article of manufacture using standard programming and/or engineering techniques.

Also, the right to claim for patent coverage a particular sub-feature, a sub-component, or a sub-element of any disclosed embodiment, singularly or in one or more sub-combinations with any other sub-feature(s), sub-component(s), or sub-element(s), is hereby unconditionally reserved by the Applicant. Also, particular sub-feature(s), sub-component(s), and sub-element(s) of one embodiment that is disclosed herein can replace particular sub-features, sub-components, and sub-elements of another embodiment disclosed herein or can supplement and be added to another embodiment unless expressly indicated otherwise by the drawings or this specification. The inventors also assert that any of the claims set forth after this detailed description can be combined with any other claim or claims regardless of whether or not there is a direct line of dependency, unless there is an express indication in this text or the drawings unambiguously indicating that such a combination is not possible. The order of the claims and the lines of dependency are irrelevant to the various ways that the features, elements, sub-elements, components, sub-components, etc. of the present disclosure can be combined and thus claimed. Further, the use of the word “can” in this document is not an assertion that the subject preceding the word “can” is unimportant or unnecessary or “not critical” relative to anything else in this document. The word “can” is used herein in a positive and affirming sense and no other motive should be presumed. More than one patentable “invention” may be disclosed in the present disclosure and it is noted that an “invention” is defined by the content of a patent claim and not by the content of descriptive text or drawings.

What is claimed is:

1. A sheet dispenser arrangement for an automated transaction machine (ATM) comprising:
a shuttle frame guide configured to be positioned in the ATM;
a shuttle frame telescopically engaged with said shuttle frame guide, said shuttle frame is moveable between first and second end limits of travel, said shuttle frame is moveable relative to said shuttle frame guide between a retracted position and an extended position; and
a shuttle assembly telescopically engaged with said shuttle frame, said shuttle assembly is moveable between first and second end limits of travel, said shuttle assembly is moveable relative to said shuttle frame between a retracted position and an extended position.

2. The sheet dispenser arrangement of claim 1 further comprising:
a transmission assembly having at least one motor with an output shaft, wherein said transmission assembly converts rotation of said output shaft of said motor into rectilinear motion of both of said shuttle frame as well as said shuttle assembly.

3. The sheet dispenser arrangement of claim 2 wherein said transmission assembly is further defined as positioned on a single side of at least one of said shuttle frame and said shuttle assembly.

4. The sheet dispenser arrangement of claim 3 wherein said transmission assembly is further defined as positioned on a single side of both of said shuttle frame as well as said shuttle assembly.

5. The sheet dispenser arrangement of claim 2 wherein said at least one motor is further defined as a single motor.

6. The sheet dispenser arrangement of claim 2 wherein said transmission assembly further comprises:
at least one first belt engaged with said output shaft whereby said at least one first belt is driven in motion by rotation of said output shaft.

7. The sheet dispenser arrangement of claim 6 wherein said transmission assembly further comprises:
a first pulley mounted on said shuttle frame for rotation relative to said shuttle frame, wherein said at least one first belt extends around said first pulley whereby motion of said at least one first belt causes rotation of said first pulley.

8. The sheet dispenser arrangement of claim 7 wherein said transmission assembly further comprises:
a gear having a first set of gear teeth and mounted on said shuttle frame for rotation relative to said shuttle frame, wherein said first pulley has a second set of gear teeth, wherein said gear and said first pulley are meshed together for concurrent rotation.

9. The sheet dispenser arrangement of claim 8 wherein said transmission assembly further comprises:
a second pulley mounted on said shuttle frame for rotation relative to said shuttle frame and spaced from said first pulley, wherein said second pulley has a third set of gear teeth, wherein said gear and said second pulley are meshed together for concurrent rotation.

10. The sheet dispenser arrangement of claim 9 wherein said transmission assembly further comprises:
at least one second belt engaged with said second pulley whereby said at least one second belt is driven in motion by rotation of said second pulley.

11. The sheet dispenser arrangement of claim 10 wherein:
said shuttle assembly further comprises at least one tab, wherein said at least one tab is fixed to said at least one second belt.

12. The sheet dispenser arrangement of claim 11 wherein:
said shuttle frame further comprises at least one slot, wherein said at least one tab is received in said at least one slot and is movable between opposite ends of said at least one slot.

13. The sheet dispenser arrangement of claim 12 wherein said transmission assembly further comprises:
a third pulley mounted on said shuttle frame for rotation relative to said shuttle frame and spaced from said first pulley and spaced from said second pulley, wherein said at least one first belt extends around said third pulley.

14. The sheet dispenser arrangement of claim 2 wherein said transmission assembly is further defined as configured to move said shuttle assembly to said extended position of said shuttle assembly while said shuttle frame is stationary and configured to move said shuttle frame to said extended position of said shuttle frame only after said shuttle assembly is moved to said extended position of said shuttle assembly.

15. The sheet dispenser arrangement of claim 2 further comprising:
a controller configured to control operation of said at least one motor; and
at least one sensor configured to sense a position of at least one of said shuttle assembly and said shuttle frame and transmit a signal to said controller corresponding to the position of at least one of said shuttle assembly and said shuttle frame, wherein said controller is configured to control operation of said at least one motor in response to said signal.

16. The sheet dispenser arrangement of claim 1 further comprising:
a locking assembly that is in a locked configuration when said shuttle assembly is in said extended position of said shuttle assembly and is in an unlocked configuration when said shuttle assembly is spaced from said extended position of said shuttle assembly.

17. The sheet dispenser arrangement of claim 16 wherein said locking assembly comprises:
a gear train including at least a first gear mounted on said shuttle frame;
at least one first belt engaged with said first gear mounted on said shuttle frame; and
at least one second belt engaged with at least a second gear of said gear train.

18. The sheet dispenser arrangement of claim 17 wherein said second gear is mounted on said shuttle frame.

19. The sheet dispenser arrangement of claim 1 further comprising:
a motor fixed relative to said shuttle frame guide and having an output shaft;
a first pulley mounted on said output shaft;
a first belt extending around said first pulley and thereby driven in motion by rotation of said output shaft by said motor;
a second pulley fixed relative to said shuttle frame, said first belt extending around said second pulley and said second pulley thereby driven in rotation by rotation of said output shaft;
a third pulley fixed relative to said shuttle frame and spaced from said second pulley;
a second belt extending around said third pulley and thereby driven in motion by rotation of said third pulley; and
a tab mounted on said second belt and thereby moving with said second belt when said second belt moves.

20. The sheet dispenser arrangement of claim 1 wherein:
said shuttle assembly further comprises at least one tab;
said shuttle frame further comprises at least one slot, wherein said at least one tab is received in said at least one slot, wherein said shuttle frame guides movement of said shuttle assembly relative to said shuttle frame through cooperative interaction between said at least one tab and said at least one slot.
